(19) United States
(12) Patent Application Publication
(10) Pub. No.: US 2006/0258412 A1
(43) Pub. Date: Nov. 16, 2006

(54) Mobile phone wireless earpiece

(76) Inventor: Serina Liu, Baldwin, CA (US)

Correspondence Address: LEONG C LEI, PMB # 1008, 1867 YGNACIO VALLEY ROAD, WALNUT CREEK, CA, 94598, US

(21) Appl. No.: 11/129,478

(22) Filed: May 16, 2005

(51) Int. Cl. H04B 1/38; H04M 1/00

(52) U.S. Cl. 455/575.2; 455/573

(57) ABSTRACT

A mobile phone wireless earpiece is comprised of an earpiece and a battery pack charger connected to each other by contacts respectively provided thereon to directly recharge the battery by clicking the earpiece to the battery pack charger for the charger to charge the earpiece through a power cable sticking out of and adapted to the type of the power source.

### BACKGROUND OF THE INVENTION

(a) Technical Field of the Invention

The present invention is related to a mobile phone wireless earpiece in radio communication, and more particularly to one that allows direct recharging of the earpiece by the battery in the battery pack charger or by a power cable extending from the battery pack charger adaptable to the type of the power source when the earpiece is clicked to the battery pack charger without removing the battery out of case of the earpiece.

(b) Description of the Prior Art

Today with a mobile phone we can communicate with others practically anywhere and at anytime without having to hunt for a pay phone booth thanks to the advanced technology. However, there are still certain occasions that prevent the direct fetch of the mobile phone. For example, while we are driving, it is dangerous to take our eyes off the road in order to grab the handset; and it is also not safe to key in the number with only one hand spare hand while the other is on the steering wheel. It is advisable to wear an earpiece. The earpiece also prevents our health from being compromised by the EM generated from the mobile phone while we are talking over the mobile phone. The earpiece of the prior art is cabled, meaning it takes a transmission wire to connect the earpiece to the mobile phone. The tangled wire could be a problem and it is not handy to remove the battery from the case of the earpiece for replacement or recharging.

### SUMMARY OF THE INVENTION

The primary purpose of the present invention is to provide a wireless earpiece that also allows direct charging without having to remove the battery from the case of the earpiece. To achieve the purpose, the present invention is essentially comprised of a wireless earpiece and a battery pack charger. Contacts are respectively provided on the surface of the earpiece and the charger to connect the earpiece and the charger to each other. When the level of the battery power stays low, just attach the earpiece to the charger and the earpiece is directly charged either by the charging battery in the charger or by a power cable extending from the charger and connected to a power source. The charger is portable for the user to charge the earpiece at any time as desired.

Another purpose of the present invention is to provide a wireless earpiece that can be picked up for answering a call while the earpiece is being charged by the charger. The power already charged into the earpiece is sufficient for a brief reception of any incoming call without interrupting the function of the mobile phone.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a preferred embodiment of the present invention.

FIGS. 2A & 2B is a schematic view showing that a wireless earphone of the preferred embodiment of the present invention is detached from a battery pack charger.

FIG. 3 is an exploded view of the preferred embodiment of the present invention.

FIG. 4 is a schematic view showing that the battery pack charger is connected to an external power source.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

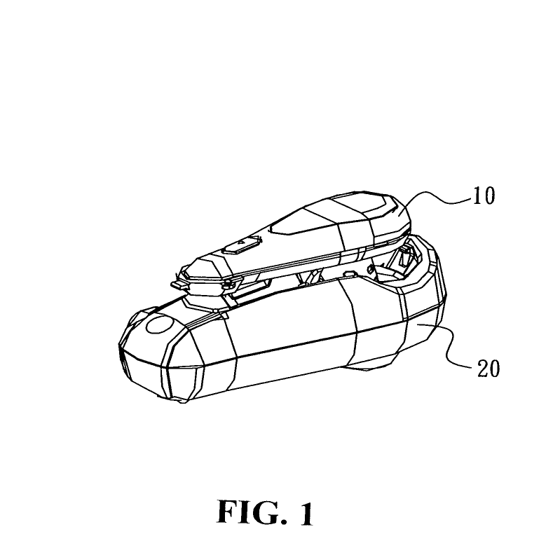

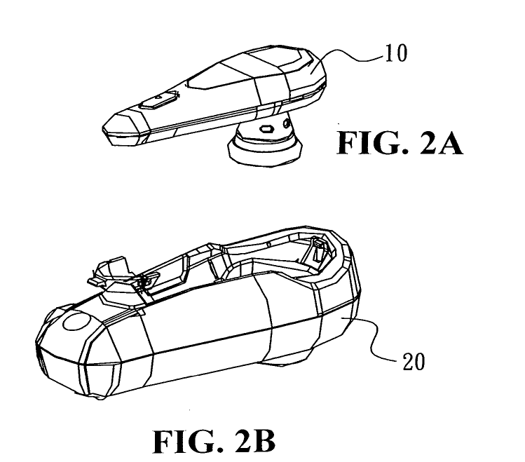

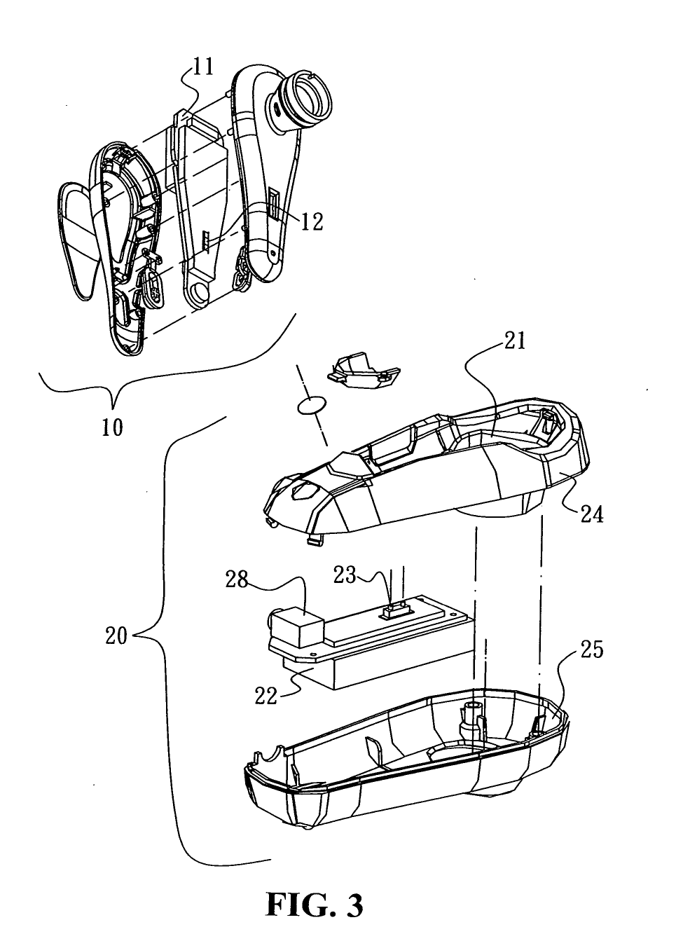

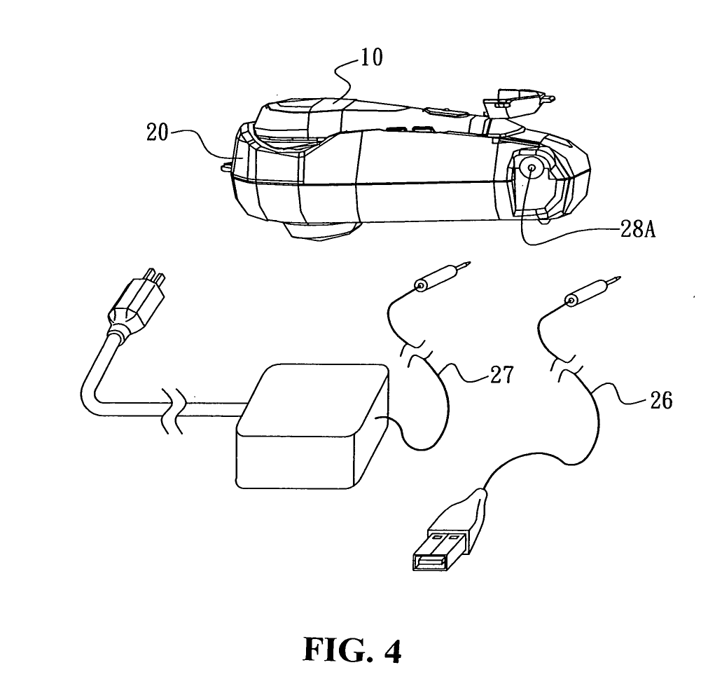

Referring to FIGS. 1 through 4, a wireless earpiece for a mobile phone is comprised of a wireless earpiece 10 and a battery pack charger 20. A recess 21 is provided at the top of the charger 20 to receive the click by the earpiece 10. Contacts 12, 23 connected through each other are respectively provided at where both of the earpiece 10 and the charger 20 are overlapped to each other. As illustrated in FIG. 3, the earpiece contains a working battery circuit 11 in a compact size as that of a small cell and the contact 12 facing the charger 20 while the charger 20 contains a charging battery 22 facing the earpiece 10 when the earpiece is attached to the charger 20, and the contact 23 slightly exposed from the recess 21. A jack 28A as illustrated in FIG. 4 protrudes from the charging battery 22 and an adapter 28 exposed out of an upper case 24 and a lower case 25 of the charger as illustrated in FIG. 3.

Now referring to FIG. 4, a cable wire (26, or 27) complying with the specification of an external power source and provided with USB plug is adapted to the socket 28A to provide power for the charging battery 22 in the charger 22. The earpiece 10 is attached to the recess 21 to be directly charged by the charger. The adapter 28 is an optional item and can be omitted by having the lead-in of the cable wire (26 or 27) directly soldered to the input end of the charging battery 22 as illustrated in FIG. 3.

The present invention by having a wireless earphone directly clicked to a dedicated battery pack charger and having the charger connected through a power cable to an external power source to charge the wireless earphone is innovative and not yet having been seen in the general market; therefore, this application is duly filed accordingly.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A mobile phone wireless earpiece includes an earpiece and a battery pack charger; two contacts being respectively provided on the surface of the earpiece and that of the charger; both of the earpiece and the battery pack charger being electrically connected to each other through those two contacts; the earphone containing a working battery circuit; the charger containing a charging battery; the charger being connected to an external power source via a power cable; and the earpiece being directly attached to the charger to be directly charged.

2. The mobile phone wireless earpiece of claim 1, wherein a recess is disposed on the top of the charger to be clicked by the earpiece; the contact from the working battery circuit in the earpiece is disposed facing the charger; and the corresponding contact on the charger is exposed out of the recess.

3. The mobile phone wireless earpiece of claim 1 or 2, wherein an adapter is provided to the charging battery to produce from and expose of the case of the charger.

4. The mobile phone wireless earpiece of claim 3, wherein the power cable complying with the specification of the external source to be plugged into the jack of the adapter relates to one provided with a USB plug.

5. The mobile phone wireless earpiece of claim 3, wherein the power cable complying with the specification of the external source to be plugged into the jack of the adapter relates to one provided with a transformer for connection to an indoor AC source.
